(19) United States
(12) Patent Application Publication
(10) Pub. No.: US 2014/0174287 A1
(43) Pub. Date: Jun. 26, 2014

(54) Rotary Vane Actuator With Continuous Vane Seal

(71) Applicant: WOODWARD, INC., Fort Collins, CO (US)

(72) Inventor: Douglas Paul Smith, Roscoe, IL (US)

(73) Assignee: WOODWARD, INC., Fort Collins, CO (US)

(21) Appl. No.: 13/726,908

(22) Filed: Dec. 26, 2012

(51) Int. Cl. F15B 15/12

(52) U.S. Cl. CPC F15B 15/12
USPC 92/121

(57) ABSTRACT

The subject matter of this specification can be embodied in, among other things, a rotary vane actuator that includes a rotor assembly including a rotor hub. The rotor hub has a first and second vane assembly disposed radially on the rotor hub. Continuous seals are disposed in continuous seal grooves along pathways provided along the vanes. A stator housing having a central chamber includes an interior surface adapted to receive the rotor assembly, the interior surface is adapted to continuously contact the first continuous seal and the second continuous seal when the rotor assembly is rotated inside of the central chamber. The vane assemblies and the stator housing define pressure chambers inside of the central chamber.

### TECHNICAL FIELD

This invention relates to an actuator device and more particularly to a pressurized rotary vane actuator device wherein the vanes of the rotor are moved by fluid under pressure.

### BACKGROUND

Rotary vane actuators are used as part of some mechanical devices, such as rotary valve assemblies. Such rotary vane actuators typically include multiple subcomponents such as a rotor and two or more stator housing components. These subcomponents generally include a number of seals to prevent leakage of fluid between hydraulic chambers of such rotary valve assemblies.

A common source of leakage in rotary vane actuators can occur across corner seals. Corner seals are used around rotor hubs to overlap the vane seals to prevent cross-vane leakage, but these seals are prone to leaks due to gaps and discontinuities between mating or near-mating surfaces.

U.S. Pat. Nos. 2,984,221; 2,966,144; and 2,951,470 disclose rotary actuators; however, the rotary vane actuator of the present disclosure is distinguishable from and has advantages over prior art rotary vane actuators.

### SUMMARY

In general, this document describes rotary vane actuators with continuous vane seals disposed on the peripheral edges of the vanes.

In a first aspect, a rotary vane actuator includes a rotor assembly including a rotor hub having a longitudinal axis, said assembly being adapted to connect to an output shaft. The rotor hub has at least a first vane assembly disposed radially on the rotor hub. The first vane assembly includes a first vane of the first vane assembly disposed substantially perpendicular to the longitudinal axis of the rotor hub, and a second vane of the first vane assembly disposed substantially perpendicular to the longitudinal axis of the rotor hub, with an integral valley member between the first vane and second vane. A first continuous seal groove is disposed continuously along a first pathway following a longitudinal peripheral face of the first vane of the first vane assembly, then along a first lateral peripheral face of the first vane, then across a first lateral face of the valley member, then along a first lateral peripheral face of the second vane of the first vane assembly, then along a longitudinal peripheral face of the second vane, then along a second lateral peripheral face of the second vane, then across a second lateral peripheral face of the valley member, and then along a second lateral peripheral face of the second vane to a point of beginning of the first pathway. A first continuous seal is disposed in the first continuous seal groove along the first pathway. At least one other second vane assembly is disposed radially on the rotor hub, and the second vane assembly includes a first vane of the second vane assembly disposed substantially perpendicular to the longitudinal axis of the rotor hub, and a second vane of the second vane assembly disposed substantially perpendicular to the longitudinal axis of the rotor hub, with an integral valley member between the first vane and second vane. A second continuous seal groove disposed continuously along a second pathway follows a longitudinal peripheral face of the first vane of the second vane assembly, then along a first lateral peripheral face of the first vane, then across a first lateral face of the valley member, then along a first lateral peripheral face of the second vane of the second vane assembly, then along a longitudinal peripheral face of the second vane, then along a second lateral peripheral face of the second vane, then across a second lateral peripheral face of the valley member, and then along a second lateral peripheral face of the second vane to a point of beginning of the second pathway. A second continuous seal is disposed in the second continuous seal groove along the second pathway. A stator housing having a central chamber includes an interior surface adapted to receive the rotor assembly, the interior surface is adapted to continuously contact the first continuous seal and the second continuous seal when the rotor assembly is rotated inside of the central chamber. The first vane and second vane assemblies and the stator housing define four pressure chambers inside of the central chamber. A portion of the first pathway of the first seal groove and the first seal that crosses at least one of the lateral peripheral faces of at least one of the valley members is spaced apart from the rotor a predetermined distance to form a fluid flow path for fluid from two pressure chambers positioned substantially opposite each other in the central chamber.

Implementations can include some, all, or none of the following features. The continuous seal can be an elastomer seal or a seal energized by other means such as a spring. The housing can include a split casing comprised of two mating portions each having a mating surface disposed toward the mating portion, each mating portion having a central longitudinal bore for receiving the rotor hub, and a cylindrical recess in the mating surface disposed coaxial with the central bore, said cylindrical recess having a diameter larger than the diameter of the central bore, said cylindrical recess adapted to receive the vanes of the rotor assembly. The housing faces can be mated together, and the two recesses in the mating surfaces can define a pressure chamber. A first external pressure source can provide a rotational fluid at a first pressure for contacting the first vane of the first vane assembly and a second external pressure source can provide a rotational fluid for contacting the second vane of the first vane assembly. Opposing pressure chambers defined by the housing and rotor can have equal surface areas as the rotor rotates within the housing. The output shaft can be configured to connect to a rotary valve stem. The stator housing can be adapted for connection to a valve housing.

In a second aspect, a rotary vane actuator includes a rotor assembly including a rotor hub having a longitudinal axis, said assembly being adapted to connect to an output shaft. The rotor hub includes at least a first vane assembly disposed radially on the rotor hub. The first vane assembly includes a first vane of the first vane assembly disposed substantially perpendicular to the longitudinal axis of the rotor hub and having a first side and a second side, and a second vane of the first vane assembly disposed substantially perpendicular to the longitudinal axis of the rotor hub, with an integral valley member between the first vane and second vane. A first continuous seal groove is disposed continuously along a first pathway following a longitudinal peripheral face of the first vane of the first vane assembly, then along a first lateral peripheral face of the first vane, then across a first lateral face of the valley member, then along a first lateral peripheral face of the second vane of the first vane assembly, then along a longitudinal peripheral face of the second vane, then along a second lateral peripheral face of the second vane, then across a second lateral peripheral face of the valley member, and then along a second lateral peripheral face of the second vane to a point of beginning of the first pathway. A first continuous seal is disposed in the first continuous seal groove along the first pathway. At least a second vane assembly is disposed radially on the rotor hub. The second vane assembly includes a first vane of the second vane assembly disposed substantially perpendicular to the longitudinal axis of the rotor hub and having a first side and a second side, and a second vane of the second vane assembly disposed substantially perpendicular to the longitudinal axis of the rotor hub, with an integral valley member between the first vane and second vane. A second continuous seal groove is disposed continuously along a second pathway following a longitudinal peripheral face of the first vane of the second vane assembly, then along a first lateral peripheral face of the first vane, then across a first lateral face of the valley member, then along a first lateral peripheral face of the second vane of the second vane assembly, then along a longitudinal peripheral face of the second vane, then along a second lateral peripheral face of the second vane, then across a second lateral peripheral face of the valley member, and then along a second lateral peripheral face of the second vane to a point of beginning of the second pathway. A second continuous seal is disposed in the second continuous seal groove along the second pathway. A stator housing having a central chamber includes an interior surface adapted to receive the rotor assembly, said interior surface adapted to continuously contact the first continuous seal and the second continuous seal when the rotor assembly is rotated inside of the central chamber. The central chamber includes a first opposing arcuate ledge and a second opposing arcuate ledge disposed radially inward along the perimeter of the chamber, said first ledge having a first terminal end adapted to contact the first vane of the first vane assembly and the second arcuate ledge adapted to contact the second vane of the first vane assembly.

Various implementations can include some, all, or none of the following features. The continuous seal can be an elastomer seal or a seal energized by other means such as a spring. The vanes of the rotor assembly and the two arcuate ledges can be configured to define four pressure chambers. Opposing pressure chambers defined by the housing and rotor can have substantially equal surface areas as the rotor rotates within the housing. A first opposing pair of the pressure chambers can be adapted to be connected to an external pressure source and a second opposing pair of the pressure chambers can be adapted to be connected to a second external pressure source. The housing can be a split casing that includes two mating portions each having a mating surface disposed toward the mating portion, each mating portion having a central longitudinal bore for receiving the rotor hub, and a cylindrical recess in the mating surface disposed coaxial with the central bore, said cylindrical recess having a diameter larger than the diameter of the central bore, said cylindrical recess adapted to receive the vanes of the rotor assembly. The housing faces can be mated together, and the two recesses in the mating surfaces can define a pressure chamber. A first external pressure source can provide a rotational fluid at a first pressure for contacting the first side of the first vane of the first vane assembly and for contacting the first side of the first vane of the second vane assembly, and the second external pressure source can provide a rotational fluid for contacting the second side of the first vane of the first vane assembly and for contacting the second side of the first vane of the second vane assembly. The first terminal end can also include a first fluid port formed therethrough and the second terminal end can include a second fluid port formed therethrough and the first fluid port can be connected to a rotational fluid provided at a first pressure and the second fluid port can be connected to a rotational fluid provided at a second pressure. The output shaft can be configured to connect to a rotary valve stem. The stator housing can be adapted for connection to a valve housing.

In a third aspect, a method of rotary actuation includes providing a rotor assembly including a rotor hub adapted to connect to an output shaft, said rotor hub having at least two opposing vane assemblies disposed radially on the rotor hub. Each of said vane assemblies includes a first vane disposed substantially perpendicular to a longitudinal axis of the rotor hub and having a first side and a second side, and a second vane disposed substantially perpendicular to a longitudinal axis of the rotor hub, with a valley member between the first vane and second vane. A continuous seal groove is disposed on a peripheral edge of the first and second vanes and the valley member, and a continuous seal is disposed in the continuous seal groove. A stator housing is provided having a central chamber including a first opposing pair of arcuate ledges and a second opposing pair of arcuate ledges disposed radially inward along the perimeter of the chamber, each of said first opposing ledges having a first terminal end and a second terminal end. A rotational fluid is provided at a first pressure and contacting the first side of the first vanes of the opposing vane assemblies with the first rotational fluid. A rotational fluid is provided at a second pressure less than the first pressure and contacting the second side of the first vanes of the opposing vane assemblies with the second rotational fluid. The rotor assembly is rotated in a first direction of rotation. The rotation of the rotor assembly is stopped by contacting at least one of the first terminal ends with at least one of the first vanes.

Various implementations can include some, all, or none of the following features. The second pressure can be increased and the first pressure can be decreased until the second pressure is greater than the first pressure, rotating the rotor assembly in an opposite direction to the first direction of rotation. The rotation of the rotor assembly in the opposite direction can be stopped by contacting at least one of the second terminal ends with at least one of the first vanes of the opposing vane assemblies. The vane assemblies can isolate the rotational fluid into a first opposing pair of chambers and a second opposing pair of chambers, and the method can also include providing the first rotational fluid at the first pressure to the first opposing pair of chambers, and providing the second rotational fluid at the second pressure to the second opposing pair of chambers. Pressure can communicate from the first chamber to the second chamber of the first opposing pair of chambers across a peripheral edge of the rotor hub. The first terminal end can also include a first fluid port formed therethrough and the second terminal end can include a second fluid port formed therethrough, and wherein providing the rotational fluid at a first pressure can be provided through the first fluid port and providing the rotational fluid at a second pressure can be provided through the second fluid port.

The systems and techniques described herein may provide one or more of the following advantages. The rotary vane actuator of the present disclosure has (1) a single continuous vane seal that replaces separate prior art rotor and stator vane seals; (2) in some implementations, eliminates the need for separate corner seals by connecting two opposing pressure chambers across the center of the rotor; (3) eliminates prior art gaps and cross seal leak paths; (4) eliminates check valves and passages in the stator housing necessary to pressure load corner seals used in prior art designs; and (5) in some implementations includes a single continuous unitary seal disposed in a single groove disposed on the peripheral edges of the vanes instead of two or more seals and associated seal support equipment disposed on the peripheral edges of the vanes; (6) pressure can communicate from the first chamber to the second chamber of the first opposing pair of chambers across the peripheral edge of the rotor hub. The details of one or more implementations are set forth in the accompanying drawings and the description below. Other features and advantages will be apparent from the description and drawings, and from the claims.

### DESCRIPTION OF DRAWINGS

FIGS. 1 and 2 are cross-sectional views of an example of a prior art rotary vane actuator.

FIGS. 3, 3A, 3B, and 4 are cross-sectional views of components of a first implementation of an example rotary vane actuator with continuous vane seals.

FIGS. 5A-5D and 6A-6D are cross-sectional views of the first example rotary vane actuator with continuous vane seals in various operational positions.

FIG. 7 is a perspective view of a stator housing component of the first example rotary vane actuator.

FIGS. 8A-8E are perspective views of the first example rotor assembly.

FIG. 9 is a flow diagram of an example process for rotating a rotary vane actuator with continuous vane seals.

### DETAILED DESCRIPTION

This document describes example rotary vane actuators with continuous vane seals. In general, by using continuous vane seals between rotor assemblies and stator housings, the use of corner seals may be eliminated. Corner seals can be associated with undesirable effects, such as reduced mechanical performance, thermal management issues, increased pump size requirements, and reduced reliability.

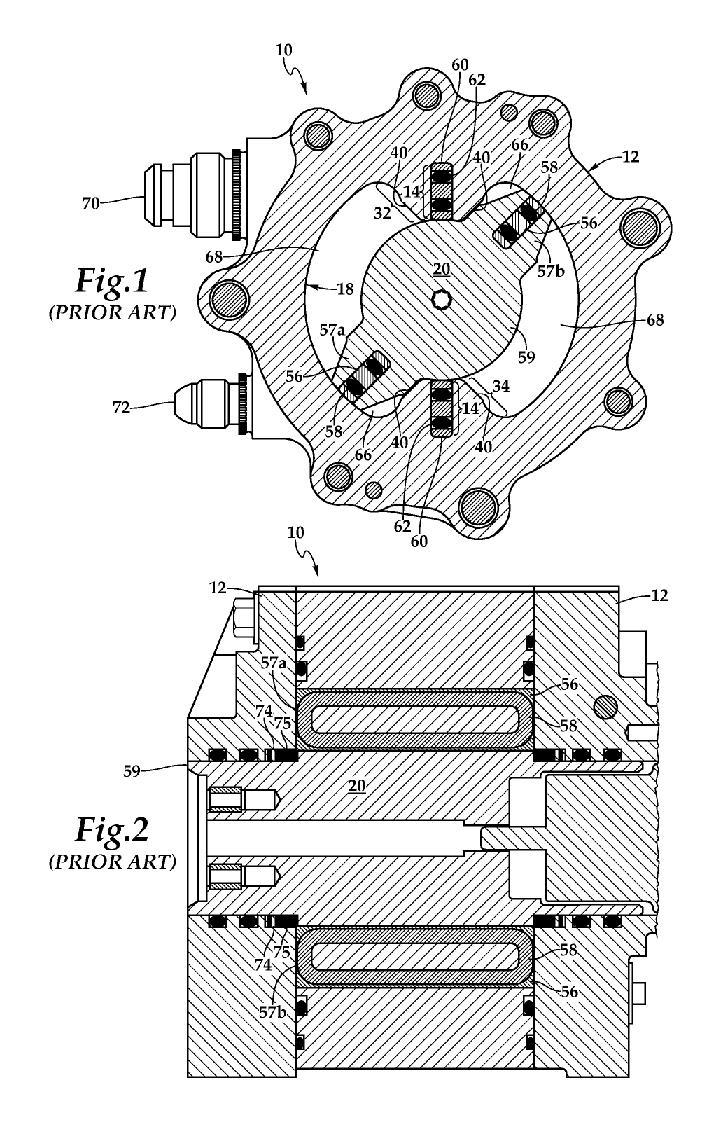

FIGS. 1 and 2 are cross-sectional views of an example of a prior art rotary vane actuator 10. The rotary actuator device 10 includes a stator housing assembly 12 and a sealing assembly generally indicated by the numeral 14. The details of each assembly 12 and 14 are set forth below.

The housing assembly 12 includes a cylindrical bore 18. As FIG. 1 shows, the cylindrical bore 18 is a chamber that encloses a cylindrical rotor 20. As FIG. 1 also shows, the rotor 20 is a machined cylindrical component consisting of a first rotor vane 57a, a second rotor vane 57b and a centered cylindrical hub 59. In some implementations, the diameter and linear dimensions of the first and second rotor vanes 57a, 57b are equivalent to the diameter and depth of the cylindrical bore 18.

The rotor 20 is able to rotate about 85 degrees total in a clockwise and counterclockwise direction relative to the stator housing assembly 12. Within the central bore 18, the stator housing 12 includes a first member 32 and a second member 34. The members 32 and 34 act as stops for the rotor 20 and prevent further rotational movement of the rotor 20. A collection of outside lateral surfaces 40 of the members 32 and 34 provide the stops for the rotor 20.

The first and second vanes 57a and 57b include a groove 56. As shown in FIG. 2, each of the grooves 56 includes one or more sealing assemblies configured to contact the wall of the cylindrical bore 18 The sealing assemblies include a cap seal, an elastomer seal 58, and a spacer. The first and second members 32 and 34 include a groove 60. Each of the grooves 60 includes one or more sealing assemblies 14 configured to contact the cylindrical rotor 20. The sealing assemblies 14 include a cap seal, an elastomer seal 62, and a spacer. The stator housing assembly 12 also includes a groove 74 that is formed to accommodate a corner seal 75.

As seen in FIG. 1, the sealing assemblies (e.g., sealing assembly 14), and the corner seal 75, define a pair of pressure chambers 66 positioned radially opposite of each other across the rotor 20, and a pair of opposing pressure chambers 68 positioned radially opposite each other across the rotor 20. In use, fluid is introduced or removed from the pressure chambers 66 through a fluid port 70, and fluid is oppositely flowed from the pressure chambers 68 through a fluid port 72.

By creating a fluid pressure differential between the pressure chambers 66 and the pressure chambers 68, the rotor 20 can be urged to rotate clockwise or counterclockwise relative to the stator housing assembly 12. In such designs, however, the corner seals 75 can be a common source of fluid leakage between the pressure chambers 66 and 68. Cross-vane leakage can also negatively impact performance, thermal management, pump sizing, and reliability of the rotary vane actuator 10.

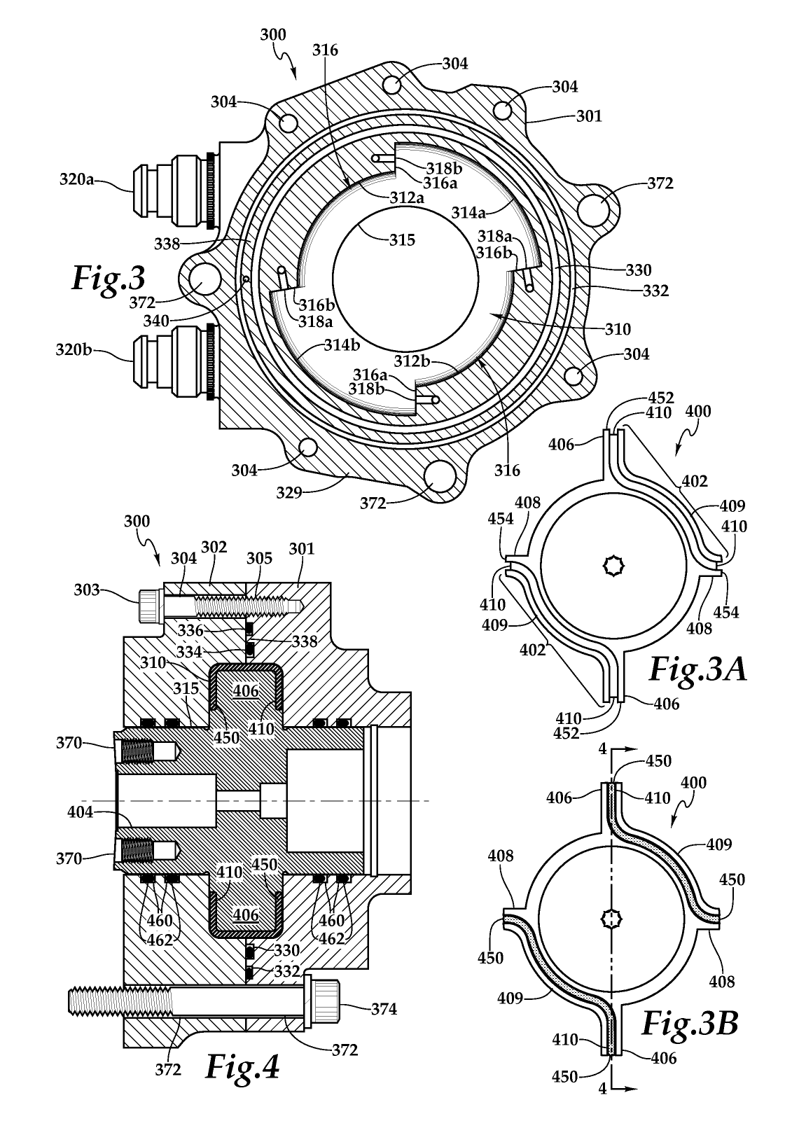

FIGS. 3, 3A, 3B, and 4 are cross-sectional views of components of an example rotary vane actuator 300 with continuous vane seals. When assembled, the rotary vane actuator includes a stator housing and a rotor assembly. In use, the rotor assembly is coupled to a mechanical device, such as a valve mechanism, and fluid is controllably applied or removed from the rotary vane actuator to cause the rotor assembly to rotate, and in turn cause the coupled mechanical device to rotate. In some implementations, the rotor assembly may also be coupled to a rotational position sensor to detect the position of the rotor assembly as it is controllably rotated.

FIGS. 3 and 4 are cross-sectional views of an example stator housing of a rotary vane actuator 300. The rotary vane actuator 300 includes a first housing assembly 301 and a second housing assembly 302. In an exemplary implementation, as shown in FIG. 4, the housing assemblies 301-302 are coupled to each other by a collection of bolts 303 that pass through corresponding holes 304 in the second housing assembly 302, and are threaded into threaded holes 305 formed within the first housing assembly 301. The first and second housing assemblies 301-302, when appropriately coupled together, form a central chamber 310.

The central chamber 310 includes a central longitudinal bore 315 disposed through a partial inner cylindrical bore section 312a and a partial inner cylindrical bore section 312b that are axially concentric with a partial outer cylindrical bore section 314a and a partial outer cylindrical bore section 314b. The partial cylindrical bore sections 312a, 312b, 314a, and 314b collectively form the surface of the central chamber 310, in which the partial cylindrical bore sections 312a, 312b, 314a, and 314b each form substantially one-quarter of the surface of the central chamber 310. The partial inner cylindrical bore sections 312a and 312b are located substantially opposite each other and in substantially perpendicular opposition to the partial outer cylindrical bore sections 314a and 314b.

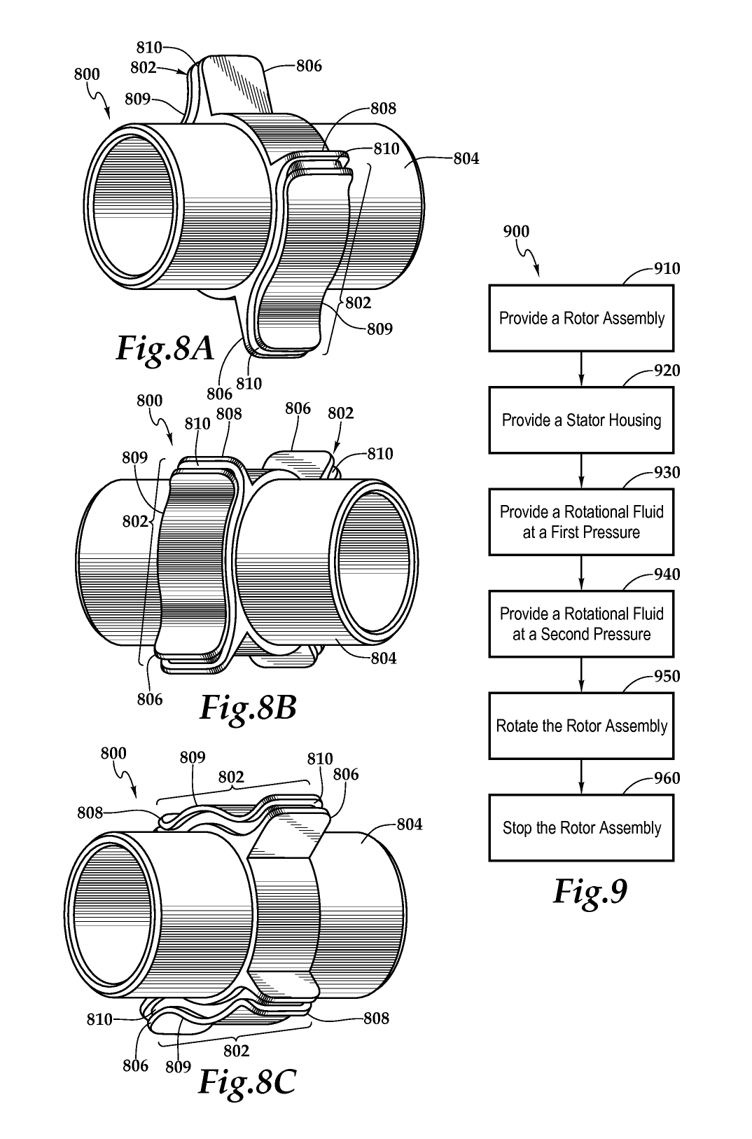

The partial inner cylindrical bore sections 312a-312b and the partial outer cylindrical bore sections 314a-314b form arcuate ledges 316a and 316b disposed radially inward along the perimeter of the central chamber 310, substantially perpendicular to the plane of view of FIG. 3. Each of the arcuate ledges includes a first terminal end 316a adapted to contact a first vane of a rotor assembly and a second terminal end 316b adapted to contact a second vane of a rotor assembly. The rotor assembly will be discussed further in the descriptions of FIGS. 3A, 3B, and 8A-8E.

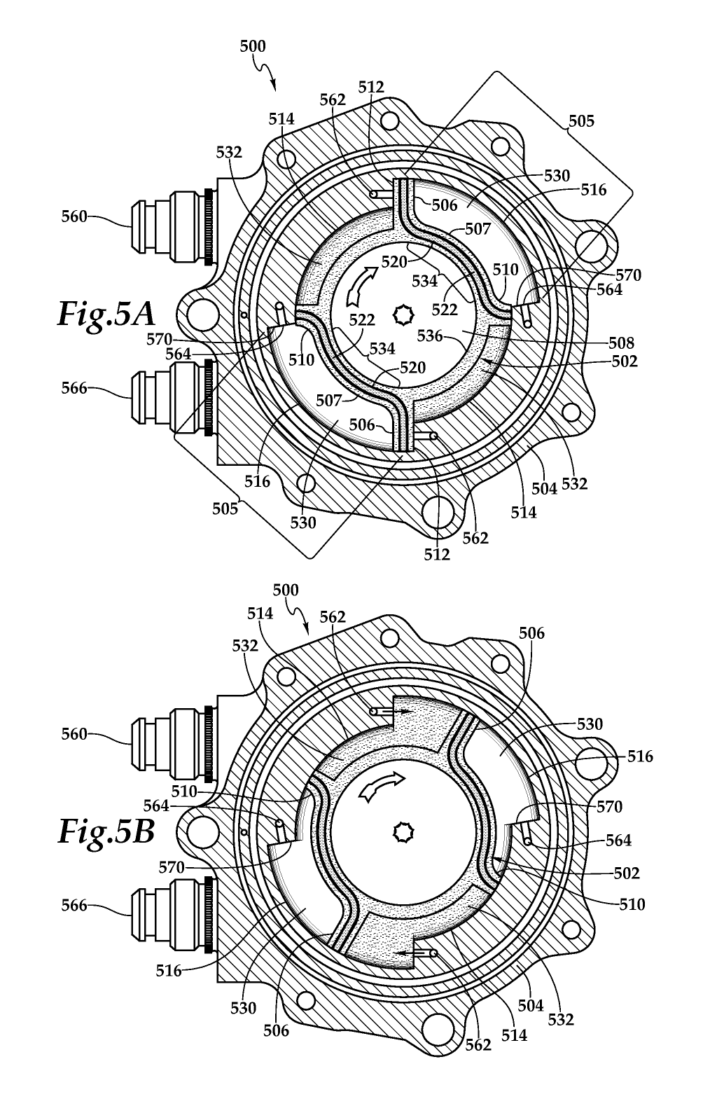

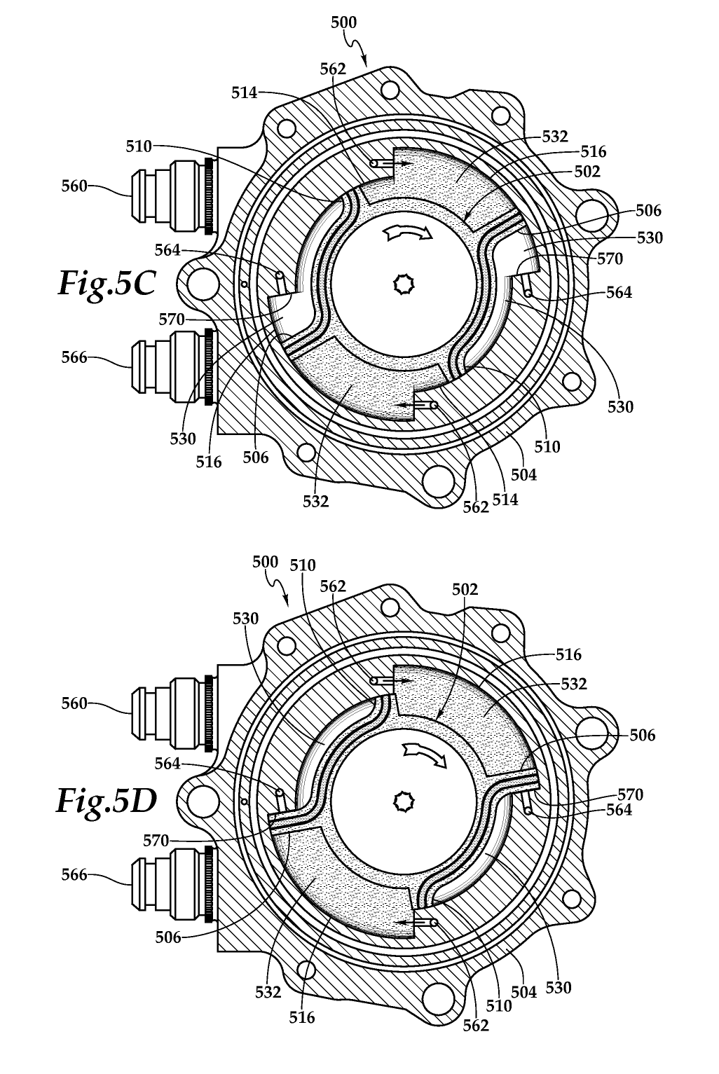

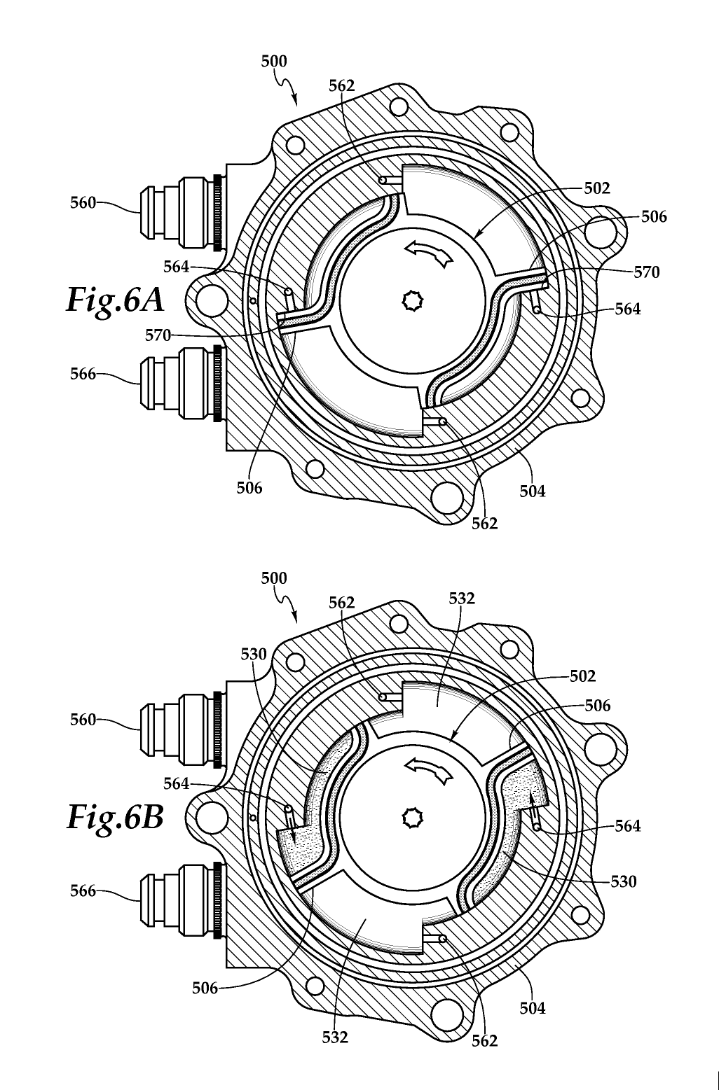

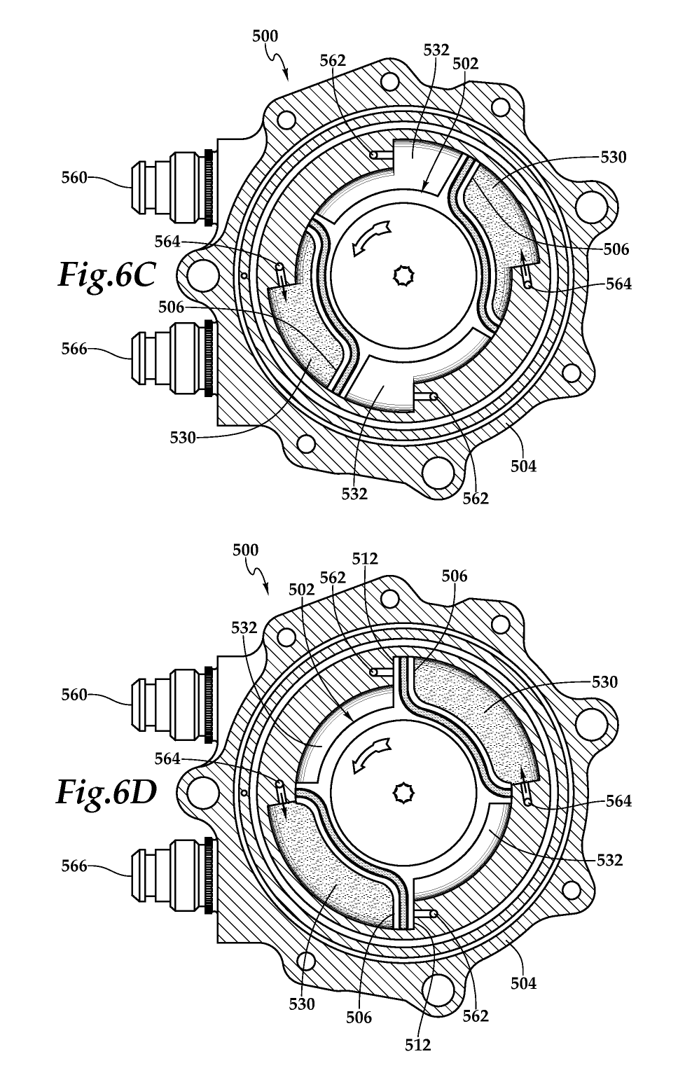

Included in or near the arcuate ledges 316a and 316b is a collection of fluid ports 318a-318b. The fluid ports 318a are in fluidic communication with a fluid port 320a, and the fluid ports 318b are in fluidic communication with a fluid port 320b. In use, a non-compressible fluid (e.g., hydraulic fluid) or compressible fluid (e.g. air, gas) can be flowed to or from the central bore 310 between the fluid ports 318a and the fluid port 320a. Similarly, a fluid can be flowed to or from the central bore 310 between the fluid ports 318b and the fluid port 320b. These fluid flows will be discussed in further detail in the descriptions of FIGS. 5A-5D and 6A-6D.

A face 329 of the first housing assembly 301 includes an inner seal groove 330 formed concentrically with an outer seal groove 332. The seal groove 330 accommodates a continuous seal 334 (e.g., an energized seal, an elastomer seal, an o-ring, a d-ring, a square seal), and the seal groove 332 accommodates a continuous seal 336. In some implementations, the continuous seal 334 can be an energized seal, energized by means such as a spring. When the second housing assembly 302 is assembled to the first housing assembly 301, the continuous seals 334-336 form a pair of concentric static seals to resist the passage of pressurized fluid from the central cavity 310 to the ambient environment. In use, the continuous seal 334 contacts a face of the second housing assembly 302 to substantially prevent the passage of pressurized fluid from the central cavity 310. Any fluid that does get past the continuous seal 334 is substantially contained in a space 338 between the seal grooves 330 and 332. A drain hole 340 is formed in the space 338 to divert fluid that leaks past the continuous seal 334 to a drain port (not shown). In some embodiments, the drain port and the drain hole 340 can maintain the space 338 at substantially ambient pressure, and can drain fluid that leaks past the continuous seal 334 before the fluid can become pressurized and possibly leak past the continuous seal 336.

Referring now to FIG. 3A, an end view of an example rotor assembly 400 is shown. The rotor assembly 400 includes two opposing vane assemblies 402 disposed radially on a rotor hub 404. Each of the vane assemblies 402 includes a first vane 406 disposed substantially perpendicular to a longitudinal axis of the rotor hub 404, and a second vane 408 disposed substantially perpendicular to the longitudinal axis of the rotor hub 404. A valley member 409 is formed between the first vane 406 and the second vane 408.

Each of the vane assemblies 402 also includes a continuous seal groove 410. The continuous seal groove 410 is formed on a peripheral edge of the first vane 406, the second vane 408, and the valley member 409. In some implementations, the continuous seal groove 410 can be a single seal groove disposed on the peripheral edge of the first vane 406, the second vane 408, and the valley member 409.

Referring now to FIG. 3B, the rotor assembly 400 is shown with a continuous seal 450 disposed in the continuous seal groove 410. In some implementations, the seal 450 can be an energized seal, an elastomer seal, an o-ring, a d-ring, a square seal, or any other appropriate form of seal. In some implementations, the seal 450 can be an energized seal, energized by means such as a spring. The first vane 406 extends from the rotor hub 404 a distance, that when the rotor assembly 400 is disposed in chamber 310, is sufficient to bring a section of the continuous seal 450, disposed along a surface 452 of the first vane 406, into sealing contact with the outer cylindrical bore sections 314a-314b (see FIG. 3). Similarly, second vane 408 extends from the rotor hub 404 a distance that is sufficient to bring a section of the continuous seal 450, disposed along a surface 454 of the second vane 408, into sealing contact with the inner cylindrical bore sections 312a-312b. As will be discussed further in reference to FIGS. 5A-5D and 6A-6D, when the rotor assembly 400 is appropriately assembled with the stator housing assembly 301-302, four fluidic chambers are formed within the rotary vane actuator 300.

Referring again to FIG. 4, the housing assemblies 301 and 302 also include a collection of seal grooves 460 and seals 462. In some implementations, the seals 462 can be an energized seal, an elastomer seal, an o-ring, a d-ring, a square seal, or any other appropriate form of seal. In some implementations, the seal 450 can be an energized seal, energized by means such as a spring. In some implementations, the seals 462 can be dynamic seals that resist the leakage of fluid from the central chamber 310 to the ambient environment along the axis of the rotor hub 404.

A collection of threaded holes 370 are formed in the rotor hub 404. The threaded holes 370 are axially perpendicular to the rotor hub 404 and, in some implementations, can provide attachment points to which an external mechanism can be attached to and rotated by the rotor hub 404. For example, a shaft for operating the internal moveable closure device of a rotary valve can be bolted to the rotor hub 404 through the threaded holes 370, and the shaft can be rotated by the rotor hub 404 to movably operate the internal movable closure device of a valve. A collection of holes 372 are formed through the housing assemblies 301 and 302. A collection of bolts, such as a bolt 374, can be passed through the holes 372. In some implementations, the bolts 374 can be passed through the holes 372 and threaded into holes in an external mounting surface (not shown). For example, the second housing assembly 302 can be mounted to a rotary valve housing by the bolts 374 to keep the housings 301 and 302 in relative position to a rotary valve housing while the rotor hub 404 rotates the shaft of the internal movable closure device of the rotary valve.

In some implementations, the housing assemblies 301 and 302 can form a split casing, in which the housing assemblies 301 and 302 can act as two mating portions, each having a mating surface disposed toward the mating portion. In some implementations, each mating portion can include the central longitudinal bore 315 for receiving the rotor hub 404, and a cylindrical recess (e.g., the cylindrical bore sections 312a-312b and 314a-314b) in the mating surface disposed coaxial with the central bore 315 in which the cylindrical recess having a diameter larger than the diameter of the central bore 315, and the cylindrical recess can be adapted to receive the vanes 406 and 408 of the rotor assembly 400. In some implementations, when the housing faces are mated together, the two recesses in the mating surfaces can define a pressure chamber.

FIGS. 5A-5D and 6A-6D are cross-sectional views of an example rotary vane actuator 500 with continuous vane seals in various operational positions. In some implementations, the rotary vane actuator 500 can be an assemblage of the first housing assembly 301, second housing assembly 302 and the rotor assembly 400 of FIGS. 3, 3A, 3B, and 4.

FIGS. 5A-5D depict the clockwise rotational operation of the actuator 500. Referring to FIG. 5A, the actuator 500 is shown with a rotor assembly 502 in a fully-counterclockwise position relative to a stator housing 504. A pair of opposing vane assemblies 505 is disposed radially on a rotor hub 508. A seal 522 is disposed in a seal groove 520 that is formed along the edges of each vane assembly 505. The seal groove 520 extends along the edges of a long vane 506, a valley member 507, and a short vane 510. In some implementations, the seal groove 520 can be a single seal groove disposed on the peripheral edge of the vane assembly 505 and the valley member 507. In some implementations, the seal 522 can be a single elastic member.

The seals 522 contact the outer walls of a pair of opposing inner arcuate ledges 514 and contact a pair of opposing outer arcuate ledges 516 to form a pair of opposing first pressure chambers 530 and a pair of opposing second pressure chambers 532. The opposing second pressure chambers 532 are in fluid communication with each other through a fluid passage 534 formed between the seal 522 and a rotor wall 536. The opposing first pressure chambers 530 are in fluid communication with each other through a fluid passage (not shown) formed within the stator housing 504. In some implementations, opposing pressure chambers can be in fluid communication to balance the fluid pressures in opposing pairs of pressure chambers.

The opposing pressure chambers 530 and 532 defined by the stator housing assembly 504 and the rotor assembly 502 have substantially equal surface areas as the rotor assembly 502 rotates within the stator housing assembly 504. In some implementations, such a configuration of equal opposing chambers supplies balanced torque to the rotor assembly 502.

In the configuration illustrated in FIG. 5A, the rotor assembly 502 is in a fully counterclockwise position, in which the long vanes 506 are in contact with hard stops 512 formed at the junctions of the inner and outer arcuate ledges 514 and 516. A pressurized fluid (e.g., hydraulic fluid) can be applied to a fluid port 560 that is in fluid communication with a pair of fluid ports 562. Similarly, the pressurized fluid can be applied to a fluid port 566 that is in fluid communication with a pair of fluid ports 564. In some implementations the opposing pressure chambers can be adapted to be connected to an external pressure source through the fluid ports 560 and the fluid ports 562, and the opposing pressure chambers 532 can be adapted to be connected to a second external pressure source through the fluid ports 566 and the fluid ports 564. In some implementations, the first external pressure source can provide a rotational fluid (e.g., hydraulic fluid) at a first pressure for contacting the long vanes 506 and the second external pressure source can provide a rotational fluid for contacting the short vane 510. In some implementations, the first rotational fluid can contact the long vane 506 of the opposing chamber and the second rotational fluid can contact the short vane 510 of the opposing chamber.

Referring now to FIG. 5B, as the fluid is applied through the fluid ports 562 the rotor assembly 502 is urged clockwise relative to the stator housing 504. As the rotor assembly 502 rotates, the long vanes 506 sweep along the outer arcuate ledges 516 and the short vanes 510 sweep along the inner arcuate ledges 514. The fluid applied through the fluid ports 562 intermingles with the fluid in the second chambers 532 and gradually fills the spaces originally occupied by the first pressure chambers 530. Fluid in the first pressure chambers 530, displaced by the rotation of the rotor assembly 502, flows out a pair of fluid ports 564 in fluid communication with a fluid port 566.

Referring now to FIG. 5C, as the fluid further fills the second pressure chambers 532, the rotor assembly 502 continues to rotate clockwise. Eventually, as depicted in FIG. 5D, the rotor assembly 502 can reach a terminal clockwise position relative to the stator housing 504. Clockwise rotation of the rotor assembly 502 stops when the long vanes 506 contact hard stops 570 formed at the junctions of the inner and outer arcuate ledges 514 and 516.

U.S. Pat. No. 2,984,221, which was mentioned previously, discloses use of continuous parallel seals on the distal peripheral edges of the vanes (blades) described in that document. However, the seals described in that patent are backed by washers and divider plates, both of which detract from the available travel of that rotor. The seals form a 5^{th} and 6^{th} pressure chamber at each end between continuous seals. Fluid leakage management and/or containment are not apparent or addressed in the prior art patent.

U.S. Pat. No. 2,966,144, also mentioned previously, discloses use of continuous parallel seals on the distal peripheral edge of the vanes described therein. Sealing elements are disposed to form pressure chambers, much the same as the corner seals 75 do in the previous descriptions of FIGS. 1 and 2, with the same disadvantages. The embodiments described in the present disclosure do not include parallel seals running down the distal peripheral edge of vanes 406 and 408. The disclosure of the U.S. Pat. No. 2,966,144 describes gates similar to the arcuate ledges 316a-316b projecting from the stator wall, the arcuate ledges 316a-316b are configured and function differently from the gates described by the U.S. Pat. No. 2,966,144. Fluid leakage management and/or containment are not addressed in the prior art patent.

FIGS. 6A-6D depict the counter-clockwise rotational operation of the actuator 500. Referring to FIG. 6A, the actuator 500 is shown in substantially the same configuration as was discussed in the description of FIG. 5D. The rotor assembly 502 is depicted as being in a terminal clockwise position relative to the stator housing 504. The long vanes 506 are in contact with the hard stops 570. Counter-clockwise rotation of the rotor assembly 502 can be accomplished by applying pressurized fluid to the fluid ports 564 through the fluid port 566.

Referring to FIG. 6B, the fluid has partly filled the first pressure chambers 530. As the first pressure chambers 530 are filled, the rotor assembly 502 is urged counter-clockwise relative to the stator housing 504. Fluid in the second pressure chambers 532 displaced by the rotation of the rotor assembly 502 flows out the fluid ports 562 to the fluid port 560.

Referring to FIG. 6C, the fluid continues to fill the first pressure chambers 530 and rotate the rotor assembly 502 counter-clockwise. Referring now to FIG. 6D, the rotor assembly 502 is shown fully rotated in the counter-clockwise direction. The counter-clockwise rotation is stopped when the long vanes 506 contact the hard stops 512.

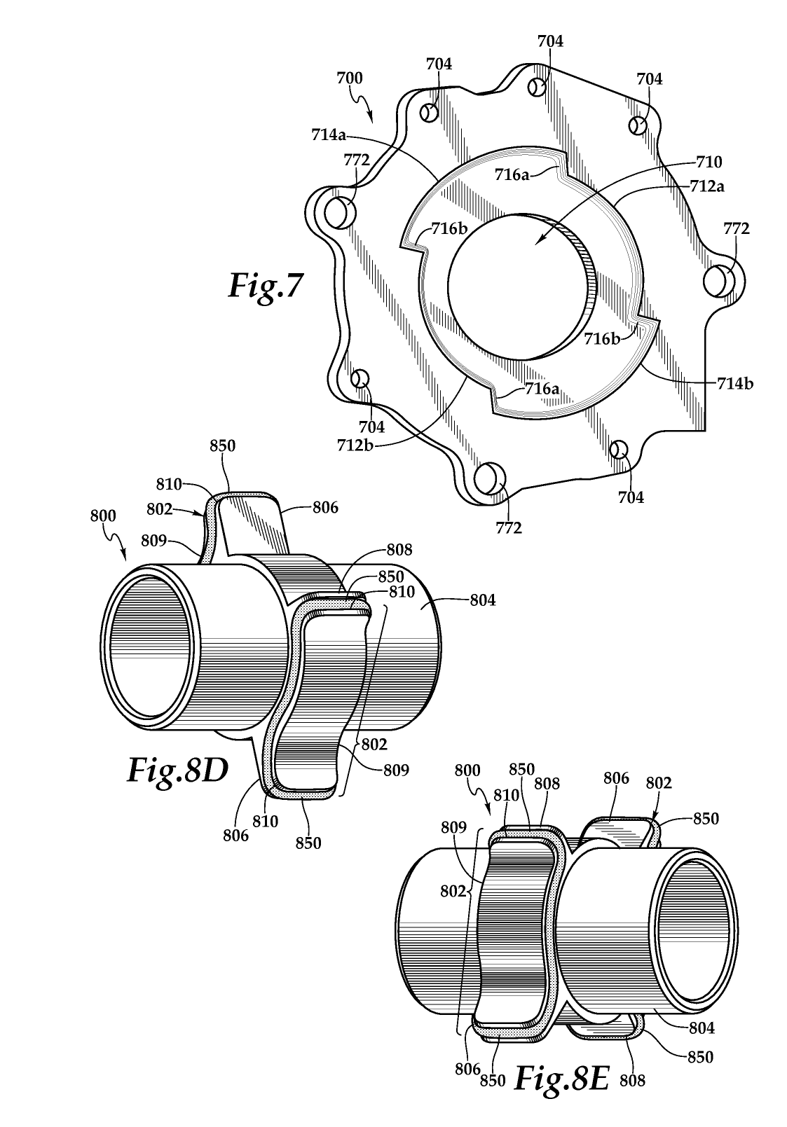

FIG. 7 is a perspective view of a stator housing component 700. In some implementations, the stator housing component 700 can be the second housing assembly 302 of FIGS. 3 and 4. The stator housing component 700 includes a collection of holes 704. In some implementations, bolts or other appropriate fasteners can be passed through the holes 704 to couple the stator housing component 700 to other components. For example, the stator housing component 700 may be coupled to the first housing assembly 301 of FIGS. 3 and 4 by passing the bolts 303 through the holes 704 and into the threaded holes 305 within the first housing assembly 301.

The stator housing component 700 includes a central chamber 710. The central chamber 710 includes a partial inner cylindrical bore section 712a and a partial inner cylindrical bore section 712b that are axially concentric with a partial outer cylindrical bore section 714a and partial outer cylindrical bore section 714b. The partial cylindrical bore sections 712a, 712b, 714a, and 714b collectively form the surface of the central chamber 710, in which the partial cylindrical bore sections 712a, 712b, 714a, and 714b each form substantially one-quarter of the surface of the central chamber 710. The partial inner cylindrical bore sections 712a and 712b are located substantially opposite each other and in substantially perpendicular opposition to the partial outer cylindrical bore sections 714a and 714b.

The partial inner cylindrical bore sections 712a-712b and the partial outer cylindrical bore sections 714a-714b form arcuate ledges disposed radially inward along the perimeter of the central chamber 710. Each of the arcuate ledges includes a first terminal end 716a adapted to contact a first vane of a rotor assembly (e.g., the rotor assembly 400) and a second terminal end 716b adapted to contact a first vane of a rotor assembly rotated in the opposite direction.

A collection of holes 772 are formed through the stator housing component 700. In some implementations, bolts (e.g., the bolts 374) or other appropriate fasteners can be passed through the holes 772 to couple the stator housing assembly to an external mounting surface (not shown).

FIGS. 8A-8E are perspective views of an example rotor assembly 800. In some implementations, the rotor assembly 800 can be the rotor assembly 400 of FIGS. 3A and 3B, or the rotor assembly 502 of FIGS. 5A-5D and 6A-6D. The rotor assembly 800 includes two opposing vane assemblies 802 disposed radially on a rotor hub 804. Each of the vane assemblies 802 includes a first vane 806 disposed substantially perpendicular to a longitudinal axis of the rotor hub 804, and a second vane 808 disposed substantially perpendicular to the longitudinal axis of the rotor hub 804. A valley member 809 is formed between the first vane 806 and the second vane 808.

Each of the vane assemblies 802 also includes a continuous seal groove 810. The continuous seal groove 810 is formed on a peripheral edge of the first vane 806, the second vane 808, and the valley member 809.

Referring now to FIGS. 8D and 8E, the rotor assembly 800 is shown with a continuous seal 850 disposed in the continuous seal groove 810. In some implementations, the seal 850 can be an energized seal, an elastomer seal, an o-ring, a d-ring, a square seal, or any other appropriate form of seal. In some implementations, the seal 450 can be an energized seal, energized by means such as a spring. When the rotor assembly 800 is properly assembled with a stator housing assembly, such as the first housing assembly 301 and second housing assembly 302 or the stator housing assembly 504, the vane assemblies 802 extend from the rotor hub 804 a distance that is sufficient to bring the continuous seal 850 into sealing contact with the walls of the central bore sections of the stator housing assembly.

FIG. 9 is a flow diagram of an example process 900 for rotating a rotary vane actuator with continuous vane seals (e.g., the rotary vane actuator 500 of FIGS. 5A-5D and 6A-6D). At step 910, a rotor assembly (e.g., the rotor assembly 502) is provided. The rotor assembly includes a rotor hub (e.g., rotor hub 508) adapted to connect to an output shaft, and has at least two opposing vane assemblies (e.g., vane assemblies 505) disposed radially on the rotor hub. Each of the vane assemblies includes a first vane disposed substantially perpendicular to a longitudinal axis of the rotor (e.g., the long vane 506) and having a first side and a second side, and a second vane disposed substantially perpendicular to a longitudinal axis of the rotor (e.g., the short vane 510), with a valley member between the first vane and second vane (e.g., the valley member 507), and a continuous seal groove disposed on a peripheral edge of the first and second vanes and the valley member (e.g., seal groove 410 and 810), a continuous seal disposed in the continuous seal groove (e.g., the seal 450 and 850).

At step 920, a stator housing (e.g., the stator housing 504) is provided. The stator housing has a central chamber including an opposing pair of arcuate ledges (e.g., arcuate ledges 514 and 516) disposed radially inward along the perimeter of the chamber, each of said ledges having a first terminal end (e.g., 316a and hard stop 512) and a second terminal end (e.g., 316b and hard stop 570).

At step 930, a rotational fluid is provided at a first pressure and contacting the first sides of the first vanes with the first rotational fluid. For example, hydraulic fluid can be applied through the fluid port 560 to the fluid ports 562 to contact the first sides of the first vanes.

At step 940, a rotational fluid is provided at a second pressure less than the first pressure and contacting the second sides of the first vanes with the rotational fluid. For example, as the rotor assembly rotates clockwise, fluid in the fluid chambers 530 is displaced and flows through the fluid ports 564 and out through the fluid port 566.

At step 950, the rotor assembly is rotated in a first direction of rotation. For example, FIGS. 5A-5C illustrate the rotor assembly 502 being rotated in a clockwise direction.

At step 960, the rotation of the rotor assembly is stopped by contacting at least one of the second terminal ends of the first ledges with at least one of the first vanes. For example, FIG. 5D illustrates the rotor assembly 502 with the long vanes 506 in contact with hard stops 512.

In some implementations, the rotor assembly can be rotated in the opposite direction to the first direction of rotation by increasing the second pressure and reducing the first pressure until the second pressure is greater than the first pressure. For example, FIGS. 6A-6C illustrate the rotor assembly 502 being rotated in a counter-clockwise direction.

In some implementations, the rotation of the rotor assembly in the opposite direction can be stopped by contacting at least one of the first terminal ends of the first ledges with at least one of the first vanes. For example, FIG. 6D shows the rotor assembly 502 at a counter-clockwise rotational hard stop.

In some implementations, the first terminal end can include a first fluid port formed therethrough and the second terminal end can include a second fluid port formed therethrough. Rotational fluid at a first pressure can be provided through the first fluid port and rotational fluid at a second pressure can be provided through the second fluid port. For example, fluid can be applied at the fluid port 560 and flowed through the fluid ports 562 formed in the hard stops 512. Similarly, fluid can be applied at the fluid port 566 and flowed through the fluid ports 562 formed in the hard stops 570.

In some implementations, the vane assemblies can isolate the rotational fluid into a first opposing pair of chambers and a second opposing pair of chambers, and the process can also include providing the first rotational fluid at the first pressure to the first opposing pair of chambers, and providing the second rotational fluid at the second pressure to the second opposing pair of chambers. For example, fluid applied or removed at the fluid port 560 flows through both fluid ports 562, and will therefore present the same pressure to both of the fluid chambers 532. Similarly, fluid applied or removed at the fluid port 566 flows through both fluid ports 564, and will therefore present the same pressure to both of the fluid chambers 530.

In some implementations, the rotor assembly can be adapted to allow pressure communication from the first chamber to the second chamber of the first opposing pair of chambers across a peripheral edge of the rotor hub. For example, the fluid chambers 532 are in fluid communication with each other across the rotor hub 508, behind the seals 522 through the fluid passages 534.

In some implementations, the rotor assembly can implement a single vane assembly with a single continuous seal. In some implementations, a single-vane rotor assembly may achieve about 170 degrees of total travel in the clockwise and counterclockwise directions of rotation. In some implementations, a two-vane rotor assembly can implement two continuous seals and three different radii of contact. In some implementations, such two-vane rotor assemblies can achieve about 115 degrees of total travel in the clockwise and counterclockwise directions of rotation.

Although a few implementations have been described in detail above, other modifications are possible. Accordingly, other implementations are within the scope of the following claims.

1. A rotary vane actuator comprising:
a rotor assembly including a rotor hub having a longitudinal axis, said rotor hub having:
at least first and second vane assemblies disposed radially on the rotor hub, each of the first and second vane assemblies comprising:
first and second vanes disposed on the rotor hub, with an integral valley member between the first vane and the second vane,
continuous seal groove disposed continuously along a pathway following a longitudinal peripheral face of the first vane, then along a first lateral peripheral face of the first vane, then across a first lateral face of the valley member, then along a first lateral peripheral face of the second vane, then along a longitudinal peripheral face of the second vane, then along a second lateral peripheral face of the second vane, then across a second lateral peripheral face of the valley member, and then along a second lateral peripheral face of the second vane to a point of beginning of the first pathway,
a continuous seal disposed in the continuous seal groove along the pathway; and
a stator housing having a central chamber having an interior surface adapted to receive the rotor assembly; and
wherein the first and second vane assemblies and the stator housing define four pressure chambers inside of the central chamber; and
wherein in at least one of the first and second vane assemblies a portion of the pathway of the seal groove and the continuous seal that crosses at least one of the lateral peripheral faces of the valley members is spaced apart from the rotor hub a predetermined distance to form a fluid flow path for fluid from two pressure chambers positioned opposite each other in the central chamber.

2. The actuator of claim 1 wherein the continuous seals each are at least one of the group consisting of an elastomer seal, an o-ring, a d-ring, or a square seal.

3. The actuator of claim 1 wherein the housing comprises a split casing comprised of:
two mating portions each having a mating surface disposed toward the mating portion:
each mating portion having:
a central longitudinal bore for receiving the rotor hub, and
a cylindrical recess in the mating surface disposed coaxial with the central bore, said cylindrical recess having a diameter larger than the diameter of the central bore, said cylindrical recess adapted to receive the vanes of the rotor assembly.

4. The actuator of claim 3 wherein when the mating surfaces of the two mating portions of the housing are mated together, the respective recesses in the mating surfaces combine to define a pressure chamber.

5. The actuator of claim 1 wherein a first external pressure source provides a rotational fluid at a first pressure for contacting the first vane of the first vane assembly and a second external pressure source provides a rotational fluid for contacting the second vane of the first vane assembly.

6. The actuator of claim 1 wherein opposing pressure chambers defined by the housing and rotor have equal surface areas as the rotor rotates within the housing.

7. The actuator of claim 1 wherein the rotor assembly is adapted to connect to an output shaft.

8. The actuator of claim 1 wherein the stator housing is adapted for connection to a valve housing.

9. The actuator claim 1 wherein the continuous seal is an energized seal.

10. The actuator of claim 1, wherein the interior surface is adapted to continuously contact the continuous seals of the first and second vane assemblies when the rotor assembly is rotated inside of the central chamber.

11. A rotary vane actuator comprising:
a rotor assembly including a rotor hub having a longitudinal axis, said rotor hub having:
at least first and second vane assemblies disposed radially on the rotor hub, each of the first and second vane assemblies comprising:
a first vane disposed on the rotor hub and parallel to the longitudinal axis of the rotor hub and having a first side and a second side, and a second vane disposed on the rotor hub, with an integral valley member between the first vane and the second vane,
a continuous seal groove disposed continuously along a pathway following a longitudinal peripheral face of the first vane, then along a first lateral peripheral face of the first vane, then across a first lateral face of the valley member, then along a first lateral peripheral face of the second vane, then along a longitudinal peripheral face of the second vane, then along a second lateral peripheral face of the second vane, then across a second lateral peripheral face of the valley member, and then along a second lateral peripheral face of the first vane to a point of beginning of the pathway,
a continuous seal disposed in the first continuous seal groove along the pathway; and
a stator housing having a central chamber having an interior surface adapted to receive the rotor assembly; and
wherein the central chamber includes a first arcuate ledge and a second opposing arcuate ledge disposed radially inward along the perimeter of the chamber, each of said first and second arcuate ledges having a first terminal end adapted to contact the respective first vane of a respective one of the first and second vane assemblies and a second terminal end adapted to contact the respective second vane of a respective one of the first and second vane assemblies.

12. The actuator of claim 11 wherein the continuous seal is at least one of the group consisting of an elastomer seal, an o-ring, a d-ring, or a square seal.

13. The actuator of claim 11 wherein the vanes of the rotor assembly and the two arcuate ledges are configured to define four pressure chambers.

14. The actuator of claim 13 wherein opposing pressure chambers defined by the housing and rotor have substantially equal surface areas as the rotor rotates within the housing.

15. The actuator of claim 13 wherein a first opposing pair of the pressure chambers is adapted to be connected to first external pressure source and a second opposing pair of the pressure chambers is adapted to be connected to a second external pressure source.

16. The actuator of claim 11 wherein the housing comprises a split casing comprised of:
two mating portions each having a mating surface disposed toward the mating portion:
each mating portion having:
a central longitudinal bore for receiving the rotor hub, and
a cylindrical recess in the mating surface disposed coaxial with the central bore, said cylindrical recess having a diameter larger than the diameter of the central bore, said cylindrical recess adapted to receive the vanes of the rotor assembly.

17. The actuator of claim 16 wherein when the mating surfaces of the two mating portions of the housing are mated together, the respective recesses in the mating surfaces combine to define a pressure chamber.

18. The actuator of claim 11 wherein a first external pressure source provides a rotational fluid at a first pressure for contacting the first side of the first vane of the first vane assembly and for contacting the first side of the first vane of the second vane assembly, and a second external pressure source provides a rotational fluid for contacting the second side of the first vane of the first vane assembly and for contacting the second side of the first vane of the second vane assembly.

19. The actuator of claim 11 wherein the first terminal end further includes a first fluid port formed therethrough and the second terminal end includes a second fluid port formed therethrough and the first fluid port is connected to a rotational fluid provided at a first pressure and the second fluid port is connected to a rotational fluid provided at a second pressure.

20. The actuator of claim 11 wherein the rotor assembly is adapted to connect to an output shaft.

21. The actuator of claim 11 wherein the stator housing is adapted for connection to a valve housing.

22. The actuator of claim 11, wherein the interior surface is adapted to continuously contact the continuous seals of the first and second vane assemblies when the rotor assembly is rotated inside of the central chamber.

23. The actuator of claim 11 wherein the continuous seal is an energized seal.

24. A method of rotary actuation comprising:
providing a rotor assembly including a rotor hub adapted to connect to an output shaft, said rotor hub having at least two opposing vane assemblies disposed radially on the rotor hub, each of said vane assemblies comprising:
a first vane disposed on the rotor hub and having a first side and a second side, and a second vane disposed on the rotor hub, with a valley member between the first vane and second vane,
a continuous seal groove disposed on a peripheral edge of the first and second vanes and the valley member, and
a continuous seal disposed in the continuous seal groove;
providing a stator housing having a central chamber including a first arcuate ledges and a second opposing arcuate ledges disposed radially inward along the perimeter of the chamber, each of said opposing ledges having a first terminal end and a second terminal end;
providing a rotational fluid at a first pressure and contacting the first side of the first vanes of the opposing vane assemblies with the first rotational fluid;
providing a rotational fluid at a second pressure less than the first pressure and contacting the second side of the first vanes of the opposing vane assemblies with the second rotational fluid;
rotating the rotor assembly in a first direction of rotation;
stopping the rotation of the rotor assembly by contacting at least one of the first terminal ends with at least one of the first vanes.

25. The method of claim 24 further including increasing the second pressure and/or reducing the first pressure until the second pressure is greater than the first pressure;
rotating the rotor assembly in an opposite direction to the first direction of rotation.

26. The method of claim 25 further including:
stopping the rotation of the rotor assembly in the opposite direction by contacting at least one of the second terminal ends with at least one of the first vanes of the opposing vane assemblies.

27. The method of claim 24 wherein the vane assemblies isolate the rotational fluid into a first opposing pair of chambers and a second opposing pair of chambers, and the method further comprises providing the first rotational fluid at the first pressure to the first opposing pair of chambers, and providing the second rotational fluid at the second pressure to the second opposing pair of chambers.

28. The method of claim 27, wherein pressure communicates from the first chamber to the second chamber of the first opposing pair of chambers across a peripheral edge of the rotor hub.

29. The method of claim 24, wherein the first terminal end further includes a first fluid port formed therethrough and the second terminal end includes a second fluid port formed therethrough, and wherein providing the rotational fluid at a first pressure is provided through the first fluid port and providing the rotational fluid at a second pressure is provided through the second fluid port.

30. A rotary vane actuator comprising:
a rotor assembly including a rotor hub having a longitudinal axis, said rotor hub having:
at least first and second opposing vane assemblies disposed radially on the rotor hub, each of the first and second vane assemblies comprising:
a first vane disposed on the rotor hub and having a first side and a second side, and a second vane disposed on the rotor hub, with a valley member between the first vane and the second vane,
a continuous seal groove disposed on a peripheral edge of the first and second vanes and the valley member, and
a continuous seal disposed in the continuous seal groove;
a stator housing having a central chamber having an interior surface adapted to receive the rotor assembly; and
wherein the first and second vane assemblies and the stator housing define four pressure chambers inside of the central chamber.
